(19) United States
(12) Patent Application Publication
(10) Pub. No.: US 2005/0102262 A1
(43) Pub. Date: May 12, 2005

(54) Method for mapping a hierarchical technical system in a relational database

(76) Inventor: Markus Nuebling, Denzlingen (DE)

Correspondence Address: FLYNN THIEL BOUTELL & TANIS, P.C., 2026 RAMBLING ROAD, KALAMAZOO, MI, 49008-1699, US

(21) Appl. No.: 10/938,064

(22) Filed: Sep. 10, 2004

(30) Foreign Application Priority Data
Sep. 11, 2003 (DE) 103 43 328.7

(51) Int. Cl. G06F 7/00

(52) U.S. Cl. 707/1

(57) ABSTRACT

The invention relates to a method for mapping a technical system modeled by a class hierarchy in a relational database, wherein, in a first step, a table, in which instances of the classes to be stored can be stored in the form of individual records, is generated for every class of the class hierarchy, wherein those class attributes to be stored are stored in columns of the table, and, in a second step, a view creation rule is stored for every class from which at least one class in the class hierarchy was derived, wherein a view associated with that view creation rule contains all instances of the associated classes, along with all instances of those derived therefrom in the form of records.

### FIELD OF THE INVENTION

The invention relates to a method for mapping a technical system modeled by a class hierarchy in a relational database.

### BACKGROUND OF THE INVENTION

Object-oriented applications represent the current state of the art. The data handled by such applications is available in the form of instances of classes, wherein these classes represent a layout specifying the attributes (data) associated with the instances of the respective classes and the methods (function) available for handling the data involved. The classes of these object-oriented applications may be derived from one another, which means that a class inherits the attributes and methods of another class, whose attributes and methods it then has. However, it may also have its own, uninherited, attributes and methods. That way complex class hierarchies in which the various classes are arrayed may result. The further up in such a class hierarchy a class is situated, the more general it is. The further down it is situated, the more specialized it is. If no other classes of the class hierarchy are situated between a first class and a second class derived therefrom, then the second class is regarded as having been derived directly from the first class. From all those classes situated further up in the class hierarchy, whose attributes and methods the second class has indirectly also inherited, it is regarded as having been indirectly derived. Every instance of a class is also an instance of all classes from which its associated class has been directly or indirectly derived. It also has all attributes and methods of those classes, whose instances it indirectly is.

Application of such object-oriented approaches are an obvious choice whenever real objects and interrelationships are to be simulated using a model, a necessity that arises primarily in conjunction with the mapping of technical processes.

Relational database management systems have long been part of the state of the art. These manage databases that allow storing data in tables, wherein the tables involved have columns and rows. However, the terms “columns” and “rows” should not be construed as implying that the columns involved are actually arranged adjacent to one another or that the rows involved are arranged one beneath the other. Representations in which horizontal “columns” are arranged one beneath the other and vertical “rows” are arranged adjacent to one another are also feasible. Within the context of relational databases, these terms are to be interpreted as implying that the columns list the attributes of every record that is stored in the database, while each row is capable of accommodating a single record, complete with its aforementioned attributes.

A relational database may have arbitrarily many tables. A query from such a relational database may involve several such tables simultaneously and specify how those tables are to be linked with one another for the purpose of the query. Many relational database management systems also allow creating views, which are virtual tables that point to data contained in other tables, but contain no data of their own. However the form of the query of data from the database is independent of whether a table or a view is being accessed.

The “structured query language” (SQL) is usually employed as the query language for relational database management systems. Virtually all commercially available relational database management systems allow accessing database data using SQL. Although relational database management systems and SQL, as their query language, are both rather old, they continue to be frequently used, since the query language involved is standardized and standardized programming interfaces based on it are still available. Furthermore, relational databases provide a fairly simple and, to non-experts, readily comprehensible, means for storing data, combined with very powerful retrieval facilities due to the flexible linkage of tables for retrieval purposes that they allow.

In addition to relational database management systems, object-oriented database management systems are also available. Such object-oriented database management systems are designed to accommodate classes and their instances. However, to date, they have not come into widespread use, compared to the total number of relational database management systems currently in use. Their use is largely hindered by the lack of a common query language.

The problem that arises in practice is how the data available for an application may be stored in a database in the form of instances and their attributes such that the data remains available during subsequent program runs. One means for obtaining this so-called “persistence of objects” is employing object-oriented databases. However, that particular solution suffers from numerous disadvantages, one of which is the widespread use of relational database management systems and their standardized query language, which would appear to make storage in a database of such a relational database management system a desirable proposition.

The approaches to storing classes and instances thereof in a relational database management system that have been pursued to date comprise the following options:

A first option involves utilizing an object-oriented extension of a relational database management system. However, such extensions are nearly always confined to software supplied by a particular software house, and are thus capable of being used with a particular relational database management system only. This option also precludes accessing stored data using a standard query language. A decision in favor of a particular relational database management system thus cannot be readily reversed, since switching to another relational database management system would require adapting the software for accessing the database involved to suit another proprietary query language.

A second option involves converting the data to be stored into binary format, storing the resultant binary data in the associated fields of database tables, and reading out those fields whenever necessary in order to reconvert it into the corresponding instances. This option suffers from numerous, serious flaws. For example, facilities for retrieving data from the database involved using one of the numerous retrieval tools available are useless, since binary data cannot be interpreted until it has been reconverted into its original format. The major benefit of employing a relational database thus cannot be exploited. Furthermore, this option does not allow selectively accessing individual attributes of instances unless they have been previously retrieved from the database in binary format and subsequently reconverted within the application involved.

A third option involves storing classes and instances thereof such that a database table having columns suitable for accommodating the attributes of those classes involved is created for every such class. For each instance of a class a record in the corresponding table is created. The disadvantage of this option is that inheritance relations among the classes are not mapped in the database. Consequentially, the database only allows unambiguous interpretations of the data stored therein in combination with a data model stored in the application involved. The structuring of the data stored in the database is inherently ambiguous. Furthermore, there is yet another problematical aspect, namely, that querying instances of a class necessarily involves searching numerous, differing tables and the total number of retrieval operations thus is correspondingly increased. Since instances of a class B, derived from another class A, are both instances of that class B and instances of the other class A, a query for all instances of the class A would require individually searching both the tables of the class A and those of all classes derived therefrom using separate database queries.

A method for storing instances of the classes of a class hierarchy can be found in U.S. Pat. No. 5,291,583. In the case of the method proposed therein, tables, each of which is associated with a given class, are created in a database. These tables have columns that represent the attributes of their respective class and rows, each of which is assigned to an instance of that class. The only columns provided in tables of derived classes are those for those particular attributes that are peculiar to the classes involved, and have not been inherited. Instances of a derived class are stored in records appearing in the table of the respective class involved, and in the tables for the direct and indirect parent classes of this class involved. Regarded as disadvantages here are that reading out an instance may thus involve numerous reading operations, and that the consistency of the stored data is endangered if, for example, a disturbance occurs within the system during the several accesses of the database required for storing an instance. This hazard of an imperfect consistency of the data stored in the database must be countered by supplementary security measures.

The purpose of the invention is creating a method that allows mapping a technical system modeled by a class hierarchy in a relational database management system, wherein the data model is mapped in its totality in order that the data involved may be accessed using tools that have not been adapted to suit that particular data model. That method is also intended to allow accessing all instances of a class using a single database query only, instead of having to conduct that query in both the table of the class involved and those of all classes directly or indirectly derived from that class. In addition, data stored in the relational database management system shall retain its consistency in the event that individual records are lost.

### SUMMARY OF THE INVENTION

According to a first variant of the invention, a method for mapping a technical system modeled by a hierarchy having several classes in a relational database is provided for that purpose, wherein instances of those classes may exist, and wherein attributes may be assigned to every class, wherein, in a first step, a table, in which instances of those classes, along with those associated attributes thereof that are to be stored, can be stored in the form of individual records, is created for every class appearing in the class hierarchy, and wherein, in a second step, a view creation rule for every class from which at least one class appearing in the class hierarchy has been derived is stored, wherein the view associated with that view creation rule includes records for all instances of the associated class as well as all instances of the classes derived from that, wherein the records for the view of a class are composed of the records of the table of that class as well as of the records of the directly derived classes' tables for those classes, from which no other classes are derived, and of the records of the directly derived classes' views for those classes, from which other classes are derived.

Within the resultant structure of the database, a table exists for each and every class, and, in addition, a view exists for those classes from which other classes have been derived. The table of a class contains only those instances that are directly generated from that class, while the view of that class contains all instances of that class, both those that have been directly generated from that particular class and those that have been generated from derived classes. The view is stored in the database management system in the form of a view creation rule that states those criteria to be applied in determining whether records are to become part of that view. The space in memory required is thus low, and independent of the number of records included in the view involved. This structure allows making very simple queries regarding the data on the instances of those classes involved. Since the instances of every class from which other classes have been derived, along with the instances of all classes that have been directly or indirectly derived from those classes, are collectively present in a view, conducting a query, in the sense of an object orientation, is a very simple matter. There is no need for separately querying all instances from the individual tables of the various classes, which would involve much more effort. Furthermore, there is no need for the querying application, or the operator who is accessing the database using a standard tool, to have knowledge regarding which classes have been derived from the class whose instances are to be queried. The database's class hierarchy may be extended without need for correspondingly adapting the application involved, if the purpose for which the application is being used allows this. This reduces the administrative effort required and avoids redundancies that might lead to errors. Applications that allow representing and processing arbitrary class hierarchies stored in a database, without need for the applications involved having any information on those class hierarchies, thus are feasible. All information characterizing the class hierarchy are contained in the database, and may be retrieved therefrom. Accessing all instances of a class, including all instances of classes derived therefrom, using a single database query would hardly be feasible without the method according to the invention.

This definition of “views”, which leads to their comprising the records of the table of the associated classes and the records of the tables, or views, of the directly derived classes, leads to a very easy administrability of the database in the case that a new class is added thereto or an existing class is removed therefrom. Only the view or the view creation rule, respectively, of that class from which the class that is to be added is to be derived or the class that is to be removed was derived, has to be modified, which means that the total number of write-accesses involved is minimized. The views of all classes situated above that class in the class hierarchy may remain unchanged, since their data is obtained from the views, or tables, of the directly derived classes, instead of being obtained directly from the table of the new class to be added or that of the class that is to be removed. In the case of a data query, the query passes recursively through the class hierarchy, wherein the views of a given class refer invariably exclusively to the table associated with that class and to the tables, or views, of the directly derived classes.

The term “technical system” refers to a real, existing system, for example, a machine, a network, a biological system, or a subsystem, i.e., in general, a large number of components or objects having a defined relationship with one another.

In a second variant of the invention, in the second step, a view creation rule for every class is stored, wherein the associated view includes records for all instances of the associated class as well as all instances of the classes derived from that class, wherein the records for the view of a class are composed of the records of the table of that class as well as of the records of the views of the classes derived from that class.

This second alternative has the advantage that, in the case of a query of instances of a class, it does not need to be known whether other classes have been derived from that class in order to decide whether the query should refer to the view or the table of that class. Instead, the query invariably refers to the view. In the case that no other classes have been derived from the class involved, that view contains the contents of the table associated with that class only. The contents of the view of a given glass is thus composed of the contents of the table associated with that class and the views of those classes directly derived from that class. In the case of this second alternative, only those views of the directly derived classes are taken into account in composing the associated view. The views of the indirectly derived classes, i.e., those that thus are situated further down the class hierarchy, are taken into account indirectly, via recursion.

In a further variant of the invention, the tables of the directly derived classes contain, in the form of columns, at least all attributes of the respective classes from which those classes have been derived.

In this manner, the mapping may take account of the inheritance system involved, under which classes invariably inherit all attributes of those classes from which they have been derived. For the results of a database query, which may consist of numerous instances originating from various tables, that means that all of those instances have at least the attributes of that class whose table was referred by the database query.

In a further variant of the invention, only those attributes are contained in the view of a respective class, that also appear contained in the table of the class.

The inheritance system, under which both those instances that are directly generated from a class and those instances that are generated from a class derived from that class constitute instances of that class, may also be taken into account using that approach. However, since this source class does not necessarily have all attributes of those derived classes from which the instances involved were generated, instances of those derived classes are incorporated into the view only with those attributes that the class from which they were derived also contains.

In a further variant of the invention, every instance stored in its table is labeled with a unique identifier, and this unique identifier of this instance appears also listed in views that contain this instance.

Employing such identifiers allows selectively accessing individual records that contain certain instances. Dispensing with such unique identifiers can create problems whenever identical records appear in a database table that cannot be selectively and separately manipulated due to the lack of distinctions usable in a database query.

In a further variant of the invention, a column in which information on the table from which every record involved originated may be stored is provided in every view defined by a view creation rule.

Employing such a column allows obtaining, in addition to simply instances and their respective attributes, for every instance contained in the result of a database query, information regarding which class is the lowest class of the class hierarchy whose instance is involved as another result thereof. That information allows retrieving that instance directly from the table of that class, and thus also obtaining as a result those attributes thereof that were not part of the first database query, since the view of the class at which the first database query was directed contains no columns for those attributes.

In a further variant of the invention, the stored information about the table is information on the name of that class from which the database originates and/or the name of the table associated with that class.

These two options represent the simplest means for accessing the record for a particular instance and its attributes. If the information involved is the name of the table, accessing may be direct, without need for drawing any conclusions regarding the names of the tables. The database may be accessed in a similarly simple manner in the case wherein the name of the class is involved, if its name allows directly concluding the name of the table, for example, by virtue of the fact that its name is identical to the name of the table, or that the name of the table is obtained simply by prefixing the name of the class with a “T-”, or similar.

Reading out information from a class hierarchy mapped in a relational database using the method according to the invention involves a first step in which all instances of a class and of all classes directly or indirectly derived therefrom that meet predefined criteria are determined from the view of that class, and a second step in which those instances determined under the first step, along with all of their attributes that are needed, are retrieved from the table of their respective class.

That method allows, in a first step, determining all instances of a given class and of all classes directly or indirectly derived therefrom that satisfy a given query condition. Employing such a query condition may be dispensed with, if all instances of that class and its derived classes are to be determined. Those instances determined are returned from the database-management system in the form of individual records, wherein each record is outfitted with the attributes of the queried class, along with a unique identifier and information on the table in which the record is found, depending upon how the query was formulated. In a second step, these two items of information, the unique identifier and the information on the table, may then be used to read out the record involved from its table, and thereby also obtain all attributes that the class associated with that particular table has.

The problem addressed by the invention is also solved by a digital storage medium, in particular, a diskette, having electronically readable control signals that are capable of interacting with a programmable computer system such that the method according to the invention is carried out.

Other features and benefits of the invention are evident from the claims and the descriptions of preferred embodiments of the invention, in conjunction with the figures.

### BRIEF DESCRIPTION OF THE DRAWINGS

FIG. 1 depicts a database structure of a first class hierarchy having three classes resulting from a first variant of the method according to the invention.

FIG. 2 depicts a database structure of the class hierarchy shown in FIG. 1 resulting from a second variant of the method according to the invention.

FIG. 3 depicts a database structure of a second class hierarchy having three classes resulting from the second variant of the method according to the invention.

### DETAILED DESCRIPTION

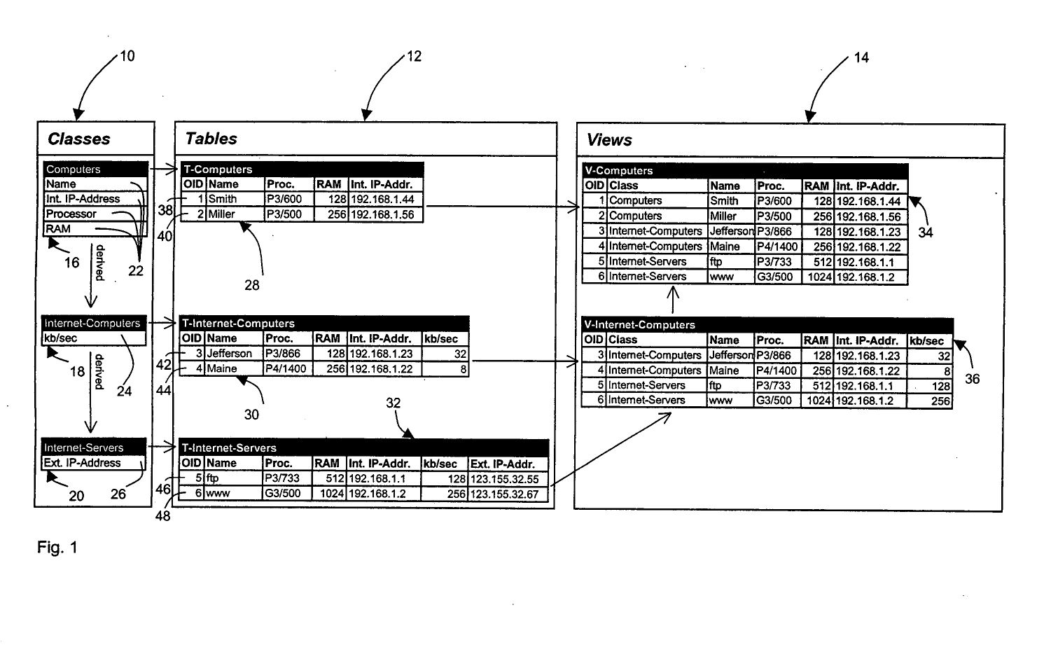

FIG. 1 depicts a class hierarchy 10 and a structure of a database based on that class hierarchy 10 that is composed of tables 12 and views 14 and has been generated using a first variant of the method according to the invention. The class hierarchy 10 has a total of three classes 16, 18, 20 situated on three hierarchical levels, and maps the computers of a network in the database. One class 16 is the uppermost of the three classes 16, 18, 20 in the class hierarchy. This class is entitled “Computers”, and has attributes 22, entitled “Internal IP-Address”, “Processor”, and “RAM”, that are characteristic of computers.

A second class 18 “Internet-Computers” is derived from this class 16 “Computers”. This second class is created for the purpose of accommodating instances representing computers of the network linked to the Internet. In addition to those attributes 22 directly inherited from the class 16 “Computers”, it has another attribute 24 “kb/sec” providing information on the transmission rate of the link to the Internet.

A third class 20 “Internet-Servers” is derived from this second class 18 “Internet-Computers”. This class 20 “Internet-Servers” has the directly and indirectly inherited attributes 22, 24 of both class 16 “Computers” and class 18 “Internet-Computers”, as well as a further attribute 26 entitled “External IP-Address” stating the IP-Address at which a server may be reached from the Internet.

According to the invention, tables 28, 30, 32 whose names are composed of the characters “T-” and the name of the associated class 16, 18, 20, “Computers”, “Internet-Computers” and “Internet-Servers” respectively, are provided in the relational database for all three classes 16, 18, 20 “Computers”, “Internet-Computers” and “Internet-Servers” respectively. The columns of these tables 28, 30, 32 “T-Computers”, “T-Internet-Computers” and “T-Internet-Servers” respectively, list the attributes of those classes 16, 18, 20 “Computers”, “Internet-Computers”, and “Internet-Servers” respectively, on which they are based, wherein the respective attributes involved may be either their own attributes, and/or attributes they have inherited. The columns of the table 28 “T-Computers” list the attributes 22 of class 16 “Computers”, those of table 30 “T-Internet-Computers” list the attributes 22, 24 of classes 16, 18 “Computers” and “Internet-Computers”, respectively, and the columns of table 32 “T-Internet-Servers” list the attributes 22, 24, 26 of classes 16, 18, 20 “Computers”, “Internet-Computers”, and “Internet-Servers”, respectively. Each of these three tables 28, 30, 32 “T-Computers”, “T-Internet-Computers”, and “T-Internet-Servers” has a column entitled “OID”, in which a unique identifier may be stored for each instance stored as record in the tables 28, 30, 32 “T-Computers”, “T-Internet-Computers”, and “T-Internet-Servers”, respectively.

In addition, a view 34, 36 having the name of its associated class 16, 18, prefixed by a “V-” (symbolizing “view”), exists for each of the two classes 16, 18 “Computers” and “Internet-Computers”, from which at least one class is derived. The columns of these views 34, 36 “V-Computers” and “V-Internet-Computers” correspond to the columns of the tables 28, 30 “T-Computers” and “T-Internet-Computers”, respectively, of the classes 16, 18 “Computers” and “Internet-Computers”, respectively, and are supplemented by another column “Class”, listing for each record appearing in the views 34, 36 “V-Computers” and “V-Internet-Computers” the respective table of the classes 16, 18, 20, “Computers” “Internet-Computers”, and “Internet-Servers” the record originated from.

Two instances of the respective associated class, each of which appears listed in the associated table in the form of a record, exist for each of the three classes 16, 18, 20 “Computers” “Internet-Computers” and “Internet-Servers”: The table 16 “T-Computers” contains two records 38, 40, the table 18 “V-Internet-Computers” contains two records 42, 44, and the table 20 “T-Internet-Servers” contains two records 46, 48.

A view creation rule referring to the view 36 “V-Internet-Computers” is defined such that the instances of the class 18 “Internet-Computers” from the table 30 “T-Internet-Computers” and instances of the class 20 “Internet-Servers” from the table 32 “T-Internet-Servers” of the class 20 “Internet-Servers” derived from the class 18 “Internet-Computers” are taken over. The view 36 entitled “V-Internet-Computers” thus contains a total of four records 42, 44 46, 48, which are supplemented by information on the respective table and/or the respective class they originate from appearing in a column “Class”. However, only those columns of those records 42, 44, 46, 48 that appear in the view 36 “V-Internet-Computers” are included, i.e., in the case of the records 46, 48 from the table entitled “T-Internet-Servers”, the column for the attribute 26 “External IP-Address” is disregarded, since the class 18 “Internet-Computers” does not have this attribute, and the view 36 “V-Internet-Computers” thus lacks a column for it.

The view creation rule referring to the view 34 “V-Computers” is defined such that the records 38, 40 of instances of the class 16 entitled “Computers” from the table 28 entitled “T-Computers” and the records 42, 44, 46, 48 of instances of the directly and indirectly derived classes 18, 20 entitled “Internet-Computers” and “Internet-Servers”, respectively, are taken over from the View 36 “V-Internet-Computers” of the directly derived class 18 “Internet-Computers”. This view 34 “V-Computers” also has a column “Class”, in which for each record information about the table of which class the record originates from is stored. Records appearing in the view 34 entitled “V-Computers” also have only those columns that appear in the table 28 entitled “T-Computers”, based on the class 16 entitled “Computers”. The records 42, 44, 46, 48, which originate from the view 36 entitled “V-Internet-Computers”, thus lack the attribute 24 “kb/sec” in the view 34 “V-Computers” since the class 16 entitled “Computers” has no corresponding attribute.

The structure described allows accessing the records of all instances of the classes 16, 18, 20 “Computers”, “Internet-Computers” and “Internet-Servers”, for example via a query directed at the view 34 entitled “V-Computers”. A corresponding SQL-query regarding all computers having more than 128 MB memory, might read: “SELECT OID, Class FROM V-Computers WHERE RAM>128”. The relational database would return a total of four records 40, 44, 46, 48 as the result of that query. The OID and class for each of those records would be returned so that the associated record, complete with all attributes, i.e., including those that do not appear listed in the form of columns in the view 34 “V-Computers”, could be retrieved from the respective tables. A corresponding SQL-query aimed at retrieving all information contained in the record 48 would read: “SELECT * FROM T-Internet-Servers WHERE OID=2”, wherein the two items of information on the record 48, class=“Internet-Servers” and OID=“2”, provided by the first SQL-Query would be utilized.

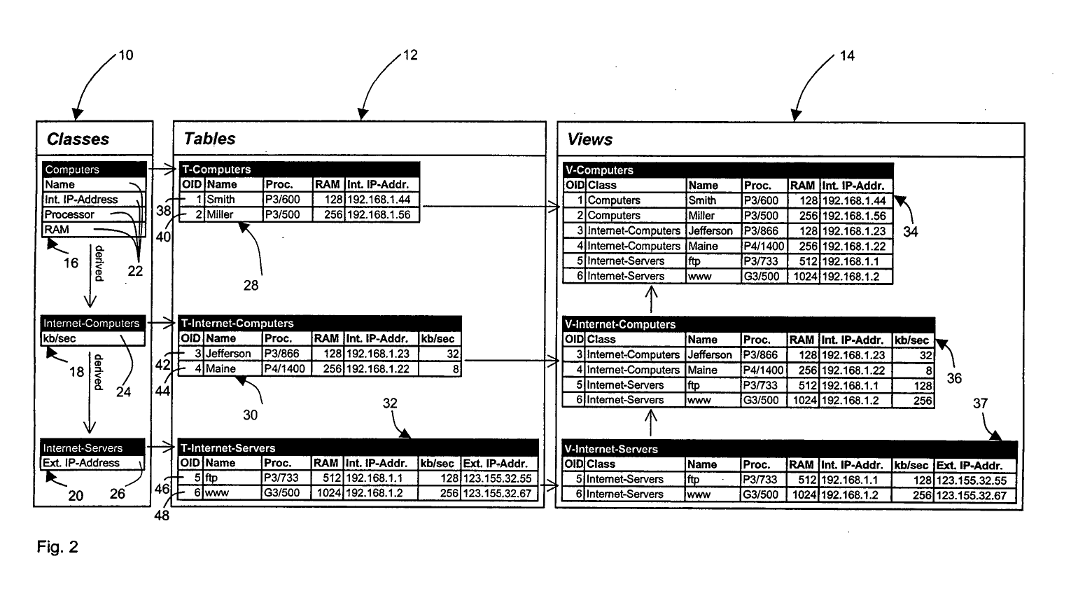

FIG. 2 depicts a constellation essentially identical to that of FIG. 1 that has been generated in accordance with the second variant of the invention. Here, once again, three classes 16, 18, 20 “Computers”, “Internet-Computers” and “Internet-Servers” are involved, each of which has a table 28, 30, 32 entitled “T-Computers”, “T-Internet-Computers”, and “T-Internet-Servers”, respectively, correlated to it, wherein the table 28 “T-Computers” lists the instances of the class 16 “Computers” in the form of the records 38 and 40, the table 30 “T-Internet-Computers” lists the instances of the class 18 “Internet-Computers” in the form of the records 42 and 44, and the table 32 “T-Internet-Servers” lists the instances of the class 20 “Internet-Servers” in the form of the records 46 and 48.

Unlike the database shown in FIG. 1, in addition to the views 34, 36 “V-Computers” and “V-Internet-Computers associated with the class 16 “Computers” and the class 18 “Internet-Computers” respectively, the database shown here also contains a view 37 entitled “V-Internet-Servers” for the class 20 “Internet-Servers” that was generated in the course of the second processing step according to the second variant of the invention. Each class 16, 18, 20 “Computers”, “Internet-Computers”, and “Internet-Servers” thus has a view of its own, regardless of whether other classes are derived from the respective class. However, the view 37 “V-Internet-Servers”, which is thus set up in addition to the views 34, 36 “V-Computers” and “V-Internet-Computers”, set up as shown in FIG. 1, contains only those records contained in the table 32 “T-Internet-Servers”. The structure of the database has also been altered with respect to the database shown in FIG. 1 in that the view 34 “V-Internet-Computers” no longer contains any records taken directly from the table 32 “T-Internet-Servers”, and instead obtains the records involved indirectly via the view 37 “V-Internet-Servers”. This approach leads to common view creation rules applying to all views 34, 36, 37 “V-Computers”, “V-Internet-Computers”, and “V-Internet-Servers” of the database since the table associated with the class of the respective view involved is the only table from which that particular view must receive records. All instances in the form of records taken over from derived classes originate from the views associated with those classes. Furthermore, this second variant of the method on which FIG. 2 is based is also particularly useful, since a user does not need to know whether other classes have been derived from a given class in order to formulate a database query directed at that class. In the case of the database shown in FIG. 1, the user would need to know that in order to decide whether the query has to be directed at the table or the view of the class to be involved.

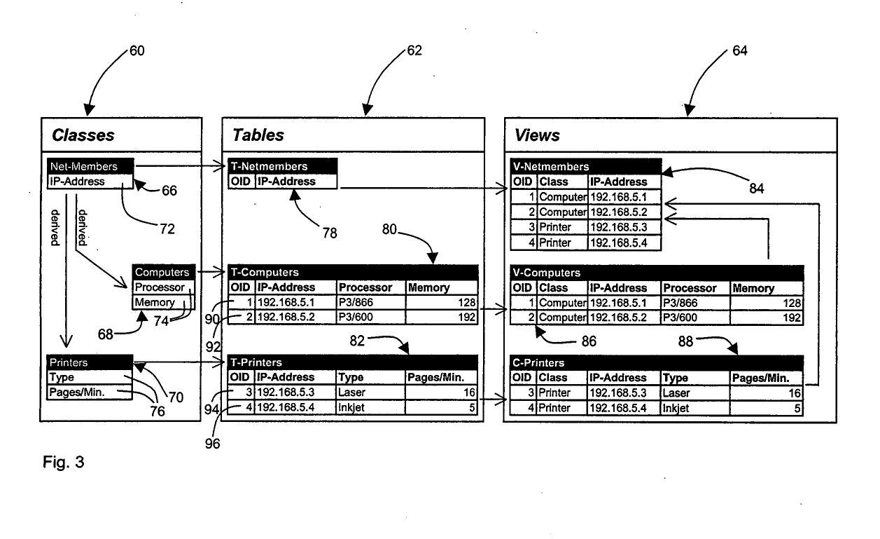

FIG. 3 depicts, once again, a database using the second variant of the method according to the invention, wherein the class structure on which that database has been based is configured differently than the class structure on which the databases shown in FIGS. 1 and 2 have been based.

Shown in FIG. 3 are a class hierarchy 60 and the structure of a database resulting by using the invention having tables 62 and views 64. Once again, the class hierarchy maps a computer-network, wherein two classes 68, 70 entitled “Computers” and “Printers”, respectively, are directly derived from a class 66 entitled “Network Members”. The class 66 entitled “Network Members” has an attribute 72 “IP-Address”, that is inherited by the classes 68 and 70 entitled “Computers” and “Printers”, respectively. The class 68 “Computers” also has two other attributes 74 “Processor” and “Memory” while the class 70 entitled “Printers” has the attributes 76 “Model” and “Pages/Min.” of its own.

The respective tables 78, 80, 82 entitled “T-Netmembers”, “T-Computers”, and “T-Printers” associated with the classes 66, 68, 70 “Netmembers”, “Computers”, and “Printers”, respectively, listing those classes' own, and inherited, attributes in the form of columns have been created in the database using the method according to the invention. Those tables also have a column “OID” in which a unique identifier for each record contained in those tables may be stored. Views 84, 86, 88 “V-Network Members”, “V-Computers”, and “V-Printers”, also exist for the classes 66, 68, 70 “Network Members”, “Computers”, and “Printers”, respectively.

The tables 80 and 82 entitled “T-Computers” and “T-Printers” contain records of instances of the associated classes 68 and 70 entitled “T-Computers” and “T-Printers”, respectively, wherein the table 80 entitled “T-Computers” contains two records 90, 92 and the table 82 entitled “T-Printers” contains two records 94, 96. No direct instances exist for the class 66 entitled “Network Members”, which means that the table 78 entitled “T-Netmembers” contains no records.

View creation rules the respective views 86 and 88 “V-Computers” and “V-Printers” for the classes 68 and 70 “T-Computers” and “T-Printers”, respectively, lead to the records 90, 92 being taken over into the view 86 “V-Computers” and the records 94, 94 being taken over into the view 88 “V-Printers”. In addition to the columns of the respective associated tables being taken over, the views 86, 88 “V-Computers” and “V-Printers” also have columns “Class” in which for every record 90, 92, 94, 96 the class is listed, the table of which the records 90, 92, 94, 96 originate from.

A view creation rule referring to the view 84 “V-Netmembers” states that the view 84 “V-Netmembers” has those columns appearing in the table 78 entitled “T-Netmembers”, plus an additional column entitled “Class”. The view creation rule referring to the view 84 “V-Netmembers” also states that the records appearing in the table 78 “T-Netmembers” are to be taken over, which, however, in this case has no effect, since no records appear in the table 78 entitled “T-Netmembers”. According to the view creation rule for the view 84 entitled “V-Netmembers”, those records 90, 92, 94, 96 that are contained in the views 80 and 82 entitled “V-Computers” and “V-Printers”, respectively, of the classes 68 and 70 entitled “Computers” and “Printers”, respectively, are taken over, wherein, however, only those columns thereof that appear the view 84 entitled “V-Netmembers” are taken over with them.

The final result is that the view 84 entitled “V-Netmembers” contains the records 90, 92, 94, 96 of all instances of those classes 68, 70 “Computers” and “Printers”, derived from the class 66 “Network Members”. The database may be accessed using the two-step method described in conjunction with FIG. 1, wherein, in a first step, a query directed at the view 84 “V-Netmembers”, under which all instances in the form of records satisfying a certain criterion are determined, and wherein, in a second step, those records obtained as a result thereof, complete with all attributes appearing therein, are retrieved from their associated tables.

1. A method to be carried out on a computer to store data, especially of a technical system, in a relational database, wherein:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
said data is available in form of instances of said classes;
in said relational database, database tables and database views can be created;
in said database tables, data is stored in the form of records; and
said database views are defined by a view creation rule specifying conditions under which said records from said database tables are included into the database view;
having the following steps:
creating one database table for each of said classes, in order to store said instances of said classes in said database tables if the form of individual records; and
creating one database view for each class, from which at least one other class is derived, wherein the respective view creation rule is defined so that the respective database view includes records for all instances of that class and for all instances of the directly and indirectly derived classes of that class, wherein the records:
originate from that class's database table,
originate from the database views of those directly derived classes, from which at least one further class is derived, and
originate from the database tables of those directly derived classes, from which no further classes are derived.

2. A method according to claim 1, wherein each of said classes has at least one attribute and wherein the tables of the directly derived classes list, in the form of columns, at least all attributes of the classes from which those derived classes were derived.

3. A method according to claim 1, wherein said database views have columns only for those of their respective class's attributes, for which the class's table has columns also.

4. A method according to claim 1, wherein:
said database tables and said database views each have one column for storing a unique identifier for each record of an instance being stored in the respective database table or view, respectively.

5. A method according to claim 1, wherein:
said database views each have one column for storing information for each record of said database view, said information being related to the table the record originates from or to the class the record's instance originates from.

6. A method according to claim 5, wherein:
said information is the name of the table or the name of the class.

7. A method to be carried out on a computer to store data, especially of a technical system, in a relational database, wherein:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
said data is available in form of instances of said classes;
in said relational database, database tables and database views can be created;
in said database tables, data is stored in the form of records; and
said database views are defined by a view creation rule specifying conditions under which said records from said database tables are included into the database view;
having the following steps:
creating one database table for each of said classes, in order to store said instances of said classes in said database tables in the form of individual records; and
creating one database view for each class, wherein the respective view creation rule is defined so that the respective database view includes records for all instances of that class and for all instances of the directly and indirectly derived classes of that class, wherein the records:
originate from that class's database table, and
originate from the database views of classes directly derived from that class, if at least one directly derived class exists.

8. A method according to claim 7, wherein each of said classes has at least one attribute and wherein the tables of the directly derived classes list, in the form of columns, at least all attributes of the classes from which those derived classes were derived.

9. A method according to claim 7, wherein said database views have columns only for those of their respective class's attributes, for which the class's table has columns also.

10. A method according to claim 7, wherein:
said database tables and said database views each have one column for storing a unique identifier for each record of an instance being stored in the respective database table or view, respectively.

11. A method according to claim 7, wherein:
said database views each have one column for storing information for each record of said database view, said information being related to the table the record originates from or to the class the record's instance originates from.

12. A method according to claim 11, wherein:
said information is the name of the table or the name of the class.

13. A method to be carried out on a computer for retrieving data of a technical system stored in a relational database, wherein:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
in said database exists one database table for each of said classes of the class hierarchy, containing the instances generated from that class in the form of records;
in said database exists one database view for each of said classes, from which at least another classes is derived;
said database views are defined such that they take over:
the records of the corresponding class's table, as well as
the records from the views of those classes being directly derived from the corresponding class and having at least one directly derived class of their own, and
the records from the tables of those classes being directly derived from the corresponding class and having no derived class of their own;
said database views have a column for storing information for each record of said views, said information being related to the table the record originates from or the class the record's instance originates from; and
wherein said data to be retrieved comprises instances of said classes which are specifiable by criteria regarding the attributes of said instances; having:
a first step for retrieving from one of said database views corresponding to one class all instances of said class and all instances of derived classes, wherein only the records of those instances are retrieved, which meet said criteria; and
a second step for retrieving all instances retrieved in the first step from the tables of their respective classes together with all required attributes.

14. A method to be carried out on a computer for retrieving data of a technical system stored in a relational database, wherein:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
in said database exists one database table for each of said classes of the class hierarchy, containing the instances generated from that class in the form of records;
in said database exists one database view for each of said classes;
said database views are defined such that they take over:
the records of the corresponding class's table, as well as
the records from the views of those classes being directly derived from the corresponding class, if the corresponding class has derived classes,
said database views have a column for storing information for each record of said views, said information being related to the table the record originates from or the class the record's instance originates from; and
wherein said data to be retrieved comprises instances of said classes which are specifiable by criteria regarding the attributes of said instances; having:
a first step for retrieving from one of said database views corresponding to one class all instances of said class and all instances of derived classes, wherein only the records of those instances are retrieved, which meet said criteria; and
a second step for retrieving all instances retrieved in the first step from the tables of their respective classes together with all required attributes.

15. A digital storage medium, having electronically readable control signals that are capable of interacting with a programmable computer system such that a method is carried out to store data of a technical system in a relational database, in which:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
said data is available in form of instances of said classes;
in said relational database, database tables and database views can be created;
in said database tables, data is stored in the form of records; and
said database views are defined by a view creation rule specifying conditions under which said records from said database tables are included into the database view;
having the following steps:
creating one database table for each of said classes, in order to store said instances of said classes in said database tables if the form of individual records; and
creating one database view for each class, from which at least one other class is derived, wherein the respective view creation rule is defined so that the respective database view includes records for all instances of that class and for all instances of the directly and indirectly derived classes of that class, wherein the records:
originate from that class's database table,
originate from the database views of those directly derived classes, from which at least one further class is derived, and
originate from the database tables of those directly derived classes, from which no further classes are derived.

16. A digital storage medium, having electronically readable control signals that are capable of interacting with a programmable computer system such that a method is carried out to store data of a technical system in a relational database, in which:
said technical system is modeled by a hierarchy of several classes;
said hierarchy has derived classes being derived from other classes;
said derived classes are directly derived from another class, if no further class exists in the hierarchy between the respective derived class and said other class;
said derived classes are indirectly derived from another class, if at least one further class exists in the hierarchy between the respective derived class and said other class;
said data is available in form of instances of said classes;
in said relational database, database tables and database views can be created;
in said database, tables data is stored in the form of records; and
said database views are defined by a view creation rule specifying conditions under which said records from said database tables are included into the database view;
having the following steps:
creating one database table for each of said classes, in order to store said instances of said classes in said database tables if the form of individual records; and
creating one database view for each class, wherein the respective view creation rule is defined so that the respective database view includes records for all instances of that class and for all instances of the directly and indirectly derived classes of that class, wherein the records:
originate from that class's database table, and
originate from the database views of classes directly derived from that class, if at least one directly derived class exists.
